(19) United States
(12) Patent Application Publication
(10) Pub. No.: US 2013/0332514 A1
(43) Pub. Date: Dec. 12, 2013

(54) Method for Controlling an Automation System and Control Device

(71) Applicant: Robert Bosch GmbH, Stuttgart (DE)

(72) Inventor: Frank Mueller, Floersbachtal-Lohrhaupten (DE)

(21) Appl. No.: 13/912,862

(22) Filed: Jun. 7, 2013

(30) Foreign Application Priority Data
Jun. 9, 2012 (DE) 10 2012 011 486.9

(51) Int. Cl. H04L 29/06

(52) U.S. Cl. CPC H04L 67/42
USPC 709/203

(57) ABSTRACT

A method for controlling an automation system includes conveying data messages to the automation system via a communication bus with a control device and/or receiving data messages from the automation system via the communication bus with the control device. Real-time messages are exchanged via the communication bus. The control device communicates with a network via a network interface and data messages are exchanged between the control device and the network via the network interface. The control device includes a plurality of processor cores. At least one processor core of the plurality of processor cores is assigned to the network interface in order to process the data messages passing via the network interface.

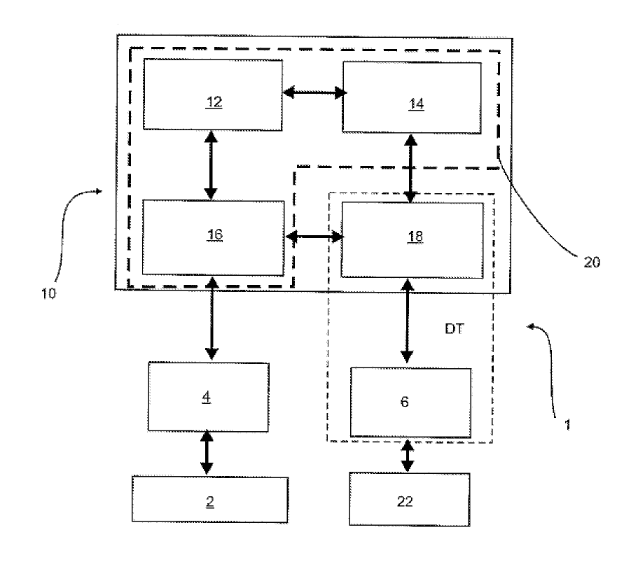

This application claims priority under 35 U.S.C. §119 to patent application no. DE 10 2012 011 486.9, filed on Jun. 9, 2012 in Germany, the disclosure of which is incorporated herein by reference in its entirety.

### BACKGROUND

The present disclosure relates to a method for controlling an automation system. In particular, the method according to the disclosure relates to an automation system which is linked into a network. Such automation systems are known from the prior art. During the operation of such systems, it was found that network activities have a negative effect on the quality of motion control and violations of real-time relationships can occur frequently.

More precisely, it was found that intensive network traffic—independently of whether it is intentional or not intentional in the environment of the system (for example DoS)—can lead to the violation of the real-time conditions of motion logic, logic or also machine tools. In detail, flooding of a network interface with messages (deliberately or not) impedes the time-critical processing of the motion and/or logic data which must be transmitted and/or received with an accuracy of microseconds via the field bus or automation bus.

This effect could always be found in performance measurements and, in extreme cases, led (in particular if the influence of the network was estimated at too low a level or the dead time was dimensioned to be too short) to a failure or to a stop of the machine at the customer. This, in turn, can lead to high costs (for example in the case of printing machines or the like). The assured determinism of the motion system is frequently violated especially due to the loading on the network interface.

From the prior art, it is known to compensate for the influence of the network interface via greater jitter tolerances (dead times) and thus giving away valuable time within a control algorithm. As a result, it is necessary to accept a reduction, unnecessary per se, in the number of axes or the number of inputs/outputs which are controlled and/or regulated via the field/automation bus, or an increase in the motion/bus cycle time.

The present disclosure is based on the object, therefore, of providing for a reduction of the influence of the network traffic for the processors (particularly the motion and/or logic; motion and/or logic processor clusters). According to the disclosure, this object is achieved by a method described herein.

### SUMMARY

In a method according to the disclosure for controlling an automation system, a control device conveys data messages to the automation system via a communication bus and/or receives data messages from the automation system. In this context, real-time messages are exchanged via this communication bus and the control device communicates with a network via a network interface and data messages are exchanged between the control device and the network via the network interface. Furthermore, the control device has a number of processor cores.

According to the disclosure, at least one processor core is assigned to the network interface in order to process the data messages passing via the network interface.

It is thus proposed that at least one processor core is exclusively responsible for controlling or processing the network communication. In this context, it is possible that only one network interface is present and this is processed by the one said processor core. However, it would also be possible that a number of network interfaces are provided and in this arrangement one or more processor cores are responsible for all or several network interfaces or one processor core for each network interface.

In the prior art, multi-processor core systems are not yet widely used to date. In devices known from the prior art, nonetheless, all cores are usually used in order to handle motion tasks better and more rapidly. When using multi-core processors, it has hitherto also been assumed that it is more efficient when all processor cores are used for enhancing the performance of the (motion) control.

In a preferred method, at least one processor core and especially a processor core assigned to the network interface performs a preprocessing process of the network messages passing via the network interface. It is proposed, therefore, that a preprocessing process such as, in particular, a preselection of network messages is carried out by the said processor core. Furthermore, the processor core can perform interrupt handling and/or the data transportation. In these cases, however, at least one and preferably also several processor cores are used exclusively for managing the network interface.

In a further advantageous method, therefore, the preprocessing process is selected from a group of preprocessing processes which includes the filtering of data messages, the selective distribution of data messages to real-time cores, the monitoring of data streams, the optimizing of data streams and the like. Advantageously, the processor core or cores allocated to the network interfaces manage the physical network interfaces of a control platform and/or allocates virtual network interfaces or data areas (shared memory/information per event).

In a further advantageous method, it is also conceivable to influence the data flow to the individual cores (as security measure). In this context, both an increased volume of data (DoS) or a virus scanner function could be conceivable. Advantageously, the said network interfaces to which the processor core is allocated are not the real-time network which is allocated to the motion or logic processor device.

Due to an increasing number of processor cores, further preprocessing of the network messages and the installation of diagnostic and monitoring capabilities are possible unproblematically. This is done advantageously without affecting the timing of the motion and/or logic process controls.

Advantageously, therefore, at least one processor core is assigned exclusively to the said network interface.

By means of the procedure according to the disclosure, interference with the determinism of automation controls by the network interfaces and their data throughput can be avoided. It is possible to achieve objects such as, for instance, the filtering of messages (of the type of a firewall), the selective distribution of messages to real-time processor cores (e.g. via shared memory or a virtual network) and the monitoring and optimizing of data streams. As a result, this leads to a better real-time performance with increased security, at the same time.

This advantageously creates a genuine real-time zone for automation solutions which, in particular, is not subject to the influence of network interfaces. As mentioned above, one or more processor cores of a multi-core processor are used exclusively for this purpose.

Advantageously, the automation system is a machine tool, a printing machine, a packaging machine, an SPS, a screw control, a robot or the like.

In a further advantageous method, the communication via the communication bus is decoupled from influences of the network interface. Advantageously, the said processor core handles tasks which are selected from a group of tasks which includes the blocking of particular MAC or IP addresses or ports (firewall) or the converting of IPv 6 messages to IPv 4 messages (a part of the real-time cluster can process only IPv 4 messages).

This creates the capability of a reactionless access to data via the network. These can be advantageously provided in the correct time (by the autonomous network cores) to the also autonomous real-time cluster.

This makes it possible to achieve maximum utilization of the processor performance in the automation innovation. The characteristic data of an automation solution can be raised in this manner (especially with regard to the number of axes or the number of inputs and outputs). The abovementioned preprocessing of the data streams (the routing to the corresponding automation module in the real-time cluster) via the network leads to further optimization of the automation system. Furthermore, relevant network subjects in the field of security such as monitoring (e.g. the proof of a manipulation), blocking cyber attacks (DoS) without influencing the reliability and real-time capability of the automation control are also possible.

It is also possible to respond in this manner to an increasing utilization of the network in the automation area.

In a further advantageous method, several processor cores also communicate with one another. In this context, a communication between the processor core which is assigned to the network interface and at least one and preferably several other processor cores is also advantageously possible. Advantageously, the communication is protected in this case. Thus, for example, a communication via a virtual network, a common memory, message queues or the like can be used. Advantageously, a memory device (for example a cache) is also assigned to at least one processor core. Advantageously, an exclusive memory device is assigned at least to the processor core which is assigned to the network interface.

The present disclosure is also directed towards a control device for controlling an automation system which has a communication bus by means of which data messages are transmitted for controlling the automation system. In this context, the communication bus is suitable for the transmission of real-time data messages. Furthermore, the control device has a network interface via which the control device communicates with a network, wherein the control device has a number of processor cores.

According to the disclosure, at least one processor core is allocated exclusively to the network interface in order to process network messages passing via the network interface.

It is, therefore, also proposed on the side of the device that, particularly in the case of using a multi-core processor system, a processor core or at least one processor core is allocated exclusively to the management of the network interface. Advantageously, at least one processor core performs a preprocessing process of the network messages passing via the network interface.

In a further advantageous embodiment, communication links exist also between the individual processor cores so that data can also be exchanged between the processor cores.

### BRIEF DESCRIPTION OF THE DRAWINGS

Further advantages and embodiments are obtained from the attached drawing, in which: The FIGURE shows a diagrammatic representation of a control device according to the disclosure.

### DETAILED DESCRIPTION

The FIGURE shows a roughly diagrammatic representation of a control device 1 according to the disclosure. This control device 1 has here a processor unit 10 which has four processor cores 12, 14, 16, 18 overall. However, it would also be possible that more or fewer processor cores are provided.

The reference symbol 4 identifies a communication bus by means of which real-time messages RTDT are exchanged for controlling an automation system 2. In this arrangement, this communication bus 4 allows bidirectional data communication.

The reference symbol 6 identifies a network interface via which the processor unit 10 can communicate with a network 22 and via which the exchange of data messages DT by means of a network 22 is also possible. In this context, in particular, an exchange of non-real-time data messages is also possible.

It can be seen that a processor core 18 is here assigned exclusively to the network interface. This is represented by the dashed rectangle which surrounds the processor core 18 and the said network interface 6. In this manner, the computing capacity of the processor core 18 can be used exclusively for processing or managing, for example filtering, data messages passing via the network interface 6. The reference symbol DT identifies the data messages passing via the network interface 6. The reference symbol 22 identifies roughly diagrammatically a network.

The further processor cores 12, 14, 16 are used for controlling the automation system 2 and can control in this manner for example the individual motion sequences. These three processor cores 12, 14, 16 are advantageously arranged in a shielded environment 20.

All features disclosed in the application documents are claimed as essential to the disclosure if they are novel compared with the prior art individually or in combination.

### LIST OF REFERENCE DESIGNATIONS

1 Control device

2 Automation system

4 Communication bus

6 Network interface

10 Processor unit

12,14,16 Processor cores allocated to the automation system

18 Processor core allocated to the network interface

20 Shielded environment

22 Network

DT Data message

RTDT Real-time data message

What is claimed is:

1. A method for controlling an automation system, comprising:
at least one of (i) conveying sent data messages to the automation system via a communication bus with a control device, and (ii) receiving received data messages from the automation system via the communication bus with the control device, the control device including a plurality of processor cores;
exchanging real-time messages via the communication bus;
communicating with a network via a network interface with the control device;
exchanging exchanged data messages between the control device and the network via the network interface; and
processing the exchanged data messages passing via the network interface with at least one processor core of the plurality of processor cores, the at least one processor core being assigned to the network interface.

2. The method according to claim 1, further comprising:
performing a preprocessing process of the exchanged data messages passing via the network interface with the at least one processor core.

3. The method according to claim 2, wherein the preprocessing process is selected from a group of preprocessing processes consisting of filtering of data messages, selective distributing of data messages to real-time cores, monitoring of data streams, and optimizing of data streams.

4. The method according to claim 1, wherein the at least one processor core is assigned exclusively to the network interface.

5. The method according to claim 1, further comprising:
decoupling communication with the network via the communication bus from influences of the network interface.

6. A control device for controlling an automation system comprising:
a communication bus via which data messages are transmitted for controlling the automation system, the communication bus being configured to transmit real time data messages;
a network interface via which the control device communicates with a network; and
a plurality of processor cores, at least one processor core of the plurality of processor cores being allocated exclusively to the network interface in order to process network messages passing via the network interface.

7. The control device according to claim 6, wherein the at least one processor core is configured to perform a preprocessing process of the network messages passing via the network interface.
